(19) United States
(12) Patent Application Publication
(10) Pub. No.: US 2010/0140153 A1
(43) Pub. Date: Jun. 10, 2010

(54) MANIFOLD BLOCK FOR REVERSE OSMOSIS SYSTEMS

(76) Inventors: Jacob Telepciak, Leomister, MA (US); Li-Shiang Liang, Harvard, MA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/610,878

(22) Filed: Nov. 2, 2009

Related U.S. Application Data
(60) Provisional application No. 61/110,284, filed on Oct. 31, 2008.

(51) Int. Cl. B01D 61/08; C02F 1/44; B01D 61/10; F15D 1/00

(52) U.S. Cl. 210/194; 210/321.6; 137/597

(57) ABSTRACT

Manifold blocks are preferably injection molded thermoplastic components of a pressurized membrane water treatment system, preferably a reverse osmosis system. A manifold block comprises a structural member of the system having at least one integral flow channel. Each channel has one or more fluidly interconnectable inlet ports and fluidly interconnectable outlet ports. The manifold block provides interconnection for modules and pumps and passageways for liquid transport. The novel manifold blocks described allow RO systems to be designed and fabricated with improved accessibility, ease of fabrication and modification in the field, and compact structure.

### CROSS REFERENCE TO RELATED APPLICATION AND PRIORITY CLAIM

This invention claims the benefit under 35 USC §119(e) of copending Provisional Application No. 61/110,284 filed Oct. 31, 2008 entitled MANIFOLD BLOCK FOR REVERSE OSMOSIS SYSTEMS which is hereby incorporated by reference in its entirety.

### FIELD OF THE INVENTION

This invention relates to manifold blocks for reverse osmosis systems, and more particularly, to manifold blocks comprising structural components having integral flow channels wherein such manifold blocks may be used to construct reverse osmosis systems.

### BACKGROUND OF THE INVENTION

A reverse osmosis (RO) process purifies water by removing over approximately 90% of most dissolved species such as ions, organic matter and biological pathogens from a water source. In this process, reverse osmosis membranes separate a pressurized water feed stream into a purified permeate stream and a concentrate stream containing the removed species.

An RO system in general comprises a pump, one or more membrane containing modules and associated piping and controls. The pump pressurizes and circulates the feed water through the membrane modules. The feed water supplied to the pump is usually pretreated by chemical and/or filtration methods to remove or reduce colloidal or particulate foulants, inorganic compounds, such as calcium, barium or iron salts or silica, which may precipitate on the membrane surface or soluble organic materials which could provide sustenance for micro-organisms. For example, feed water may be treated with coagulants or flocculants, single or two stage granular media, cartridge filters or ultrafiltration or microporous membrane filtration, or some combination of these.

While practitioners may commonly use once through flow in reverse osmosis operations, practitioners also use concentrate recirculation, where the concentrate is returned to the feed storage tank. In relatively small applications, such as waste water, where intermittent or non-continuous discharge is used, a batch or semi-batch method is common. A batch operation is one in which the feed is collected and stored in a tank or other reservoir, and periodically treated. In semi-batch mode, the feed tank is refilled with the feed stream during operation.

The RO system may have single or multiple stages. In a single stage system, the feed passed through one or more pressure vessel arrange in parallel. Each pressure vessel will have one or more membrane modules in series. The number of stages is defined as the number of single stages the feed passes through before exiting the system. Permeate staged systems use permeate from the first stage as feed for the second stage, and if multiple stages are used, permeate from a stage just prior is used as feed for the following stage. In as reject staged system, the reject stream of a stage is sent to become the feed stream of a subsequent, usually the next, stage. Reject, concentrate and retentate and similar terms have synonymous meanings in RO processing

The membrane containing modules may be spiral wound flat sheet membrane modules, hollow fiber modules or plate and frame type cassettes. The modules a supported generally on metal frames, although other materials may be used, and the various piping and electrical and/or pneumatic control lines are connected. For systems containing multiple modules the complexity of the piping and control wiring or pneumatic lines increases and practitioners look for ways to simplify system design and construction.

U.S. Pat. No. 4,741,823 describes a flow control manifold block for a cross-flow membrane system. The flow control manifold block incorporates much of the plumbing and other operative elements of the system, including the various inlet, concentrate, permeate and recycle conduits as well as the various check-valves, flow control orifices, conductivity probes, valves, etc. The block also has a preset concentrate orifice and a preset recycle orifice in the manifold block to eliminate skilled monitoring, maintenance or adjustment of the system.

U.S. Pat. No. 5,045,197 describes a unitary header manifold for integrating multiple system components into a relatively compact and organized package adapted for facilitated assembly. The header manifold has a simplified construction with a single elongated gallery passage for directing an incoming supply of tap water or the like through a sequence of filtration and reverse osmosis stages, wherein these stages are supported by the manifold for facilitated access to and periodic replacement of filtration and reverse osmosis media.

U.S. Pat. No. 6,436,282 describes a semi-permeable membrane filter system, which may include pre-RO and post-RO filter units, utilizes a manifold and a single control module that includes all of the basic valve and flow control components for the system (with the exception of the user on-off faucet control). The control module is readily accessible for easy servicing and replacement of the module. The manifold is operatively connected to the membrane filter unit and includes a supply flow path for directing a pressurized flow of raw water to the membrane filter unit, a permeate flow path for directing membrane permeate (pure water) to a pressurized storage tank, and a brine flow path for directing membrane concentrate to a drain. The control module includes a demountable housing that is attached directly to the manifold and entirely enclosing therein a pressure responsive supply flow shutoff valve, a brine flow control valve, and a permeate flow check valve, as well as the respective interconnections between the manifold and the several valves.

U.S. Pat. No. 7,387,210 describes a combined filter cartridge and manifold. The manifold facilitates substantially fail-safe and substantially drip-free filter cartridge removal and replacement. The manifold is coupled to a suitable water supply and includes inlet and outlet fittings for quick and easy respective connection with water inlet and outlet ports on the filter cartridge. A pivotal manifold cap is mounted on the manifold for pivoting movement between a normal closed or lowered position overlying and retaining the filter cartridge in proper connected relation with the manifold fittings and the water supply, and an open or raised position for disconnection of the water supply before permitting filter cartridge separation from the manifold. Check valves at the cartridge inlet and outlet ports prevent water leakage from the removed cartridge.

The manifolds of the prior art are designed and manufactured to a specific application. They are not contemplated to be re-engineered by changing flow regimes. For instance, they cannot change from series arrangement to a parallel arrangement or vice versa. In the manifolds of the prior art, modules in excess of the capacity of the manifold in use can only be added by adding another separate manifold. That is, there is no method of incremental addition.

Embodiments of the present invention may be reconfigured to adapt to changing demands on the system. As will be described, the manifold blocks of the present disclosure allow modules to be added or subtracted, flow regime changed, and system designed easily modified. The manifold blocks also may be used to act as structural components of the system, thereby reducing the amount of iron structure. An additional benefit to a practitioner is the simplified arrangement of piping.

It is expected that this invention will reduce significantly the material and labor cost for assembling an RO system as well as the size. The invention will also reduce the labor necessary for replacement of the feed pump and/or the RO elements.

### BRIEF DESCRIPTION OF THE DRAWINGS

FIG. 1a shows a three dimensional view of the manifold block.

FIG. 1b illustrates flow in a permeate passage.

FIG. 1c as a cutaway drawing of a manifold block showing an elbow arrangement.

FIGS. 2a-2f illustrate six cutaway views of various flow configurations.

FIG. 3 shows two manifold blocks with an interconnecting pipe segment.

FIG. 4 shows two manifold blocks with boss and hole arrangement for alignment.

FIG. 5 shows two rows of blocks attached back to back with bolts and nuts.

FIG. 6a illustrates that use of two sets of two rows of blocks clamped between two vertical members to act as structural members.

FIG. 6b is an exploded view showing side panel attachment for increased rigidity.

FIG. 6c shows a complete RO system structure.

FIG. 7 is a process schematic of an RO system with five elements.

FIG. 8 shows the high pressure flows of the bottom set of manifold blocks of FIG. 6a,b,c.

FIG. 9 shows a complete RO system with attached housings.

FIG. 10 is a process schematic of an RO system having seven RO elements in a 3-2-11 configuration.

### SUMMARY OF THE INVENTION

Embodiments of the present invention are injection molded manifold blocks having integral flow channels. The blocks are used in the fabrication and operation of an RO system. The blocks may act as structural members to increase the rigidity of the fabricated system. Membrane module containing housing are connected to the blocks and feed, reject and permeate flows are transported through the system by the integral flow channels.

### DETAILED DESCRIPTION OF THE INVENTION

Reverse osmosis systems are used in many sizes, from undersink systems for home drinking and cooking use to large seawater desalination plants. The different sized systems have their own design requirements. A common type, packaged RO systems in the range of approximately 1 gallon/minute (˜4 liter/min) to approximately 25 gallons per minute output (˜100 liter/min) are used in many industrial applications. Users of these systems generally require easy-to-use, compact and economical equipment. In most cases the system fabricator is required to furnish a custom designed system to meet the specific needs of the user. Since these systems are very often operated by inexperienced workers, many times on intermittent schedules, users desire that the system be easily accessible for change-outs and routine maintenance.

To meet these various demands, The inventors of the several embodiments of the novel manifold blocks described herein have found RO systems can be designed and fabricated to have improved accessibility, ease of fabrication and modification in the field, and compact structure.

Embodiments of this invention cover the use of molded modular manifold blocks with internal flow passages to provide part of the structural support for the RO housings and feed pump, thereby eliminating or reducing the requirements of a metallic frame. In addition, embodiments of the invention cover the use of molded modular manifold blocks to provide the flow connections between the pump and the housings and connecting the housings, thereby reducing the amount of fabricated piping necessary. In addition, embodiments of the invention provide locations for flow controls and instrumentation.

Important components in a reverse osmosis (RO) system include the membrane modules, housed in pressure vessels (housings), and the feed pressurization pump. These components are typically mounted on a metallic frame and connected by piping. The piping is typically assembled from plastic or metallic components. Other system components such as instrumentation and controls are installed on the piping and on the frame.

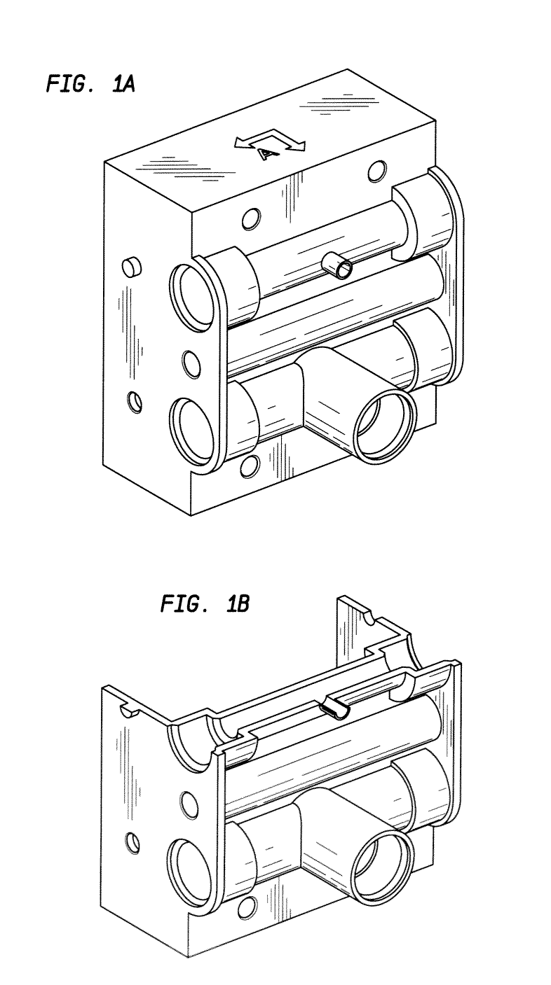

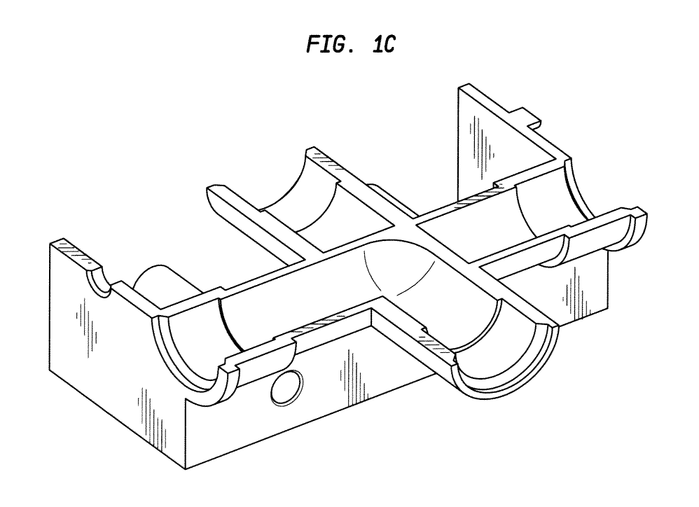

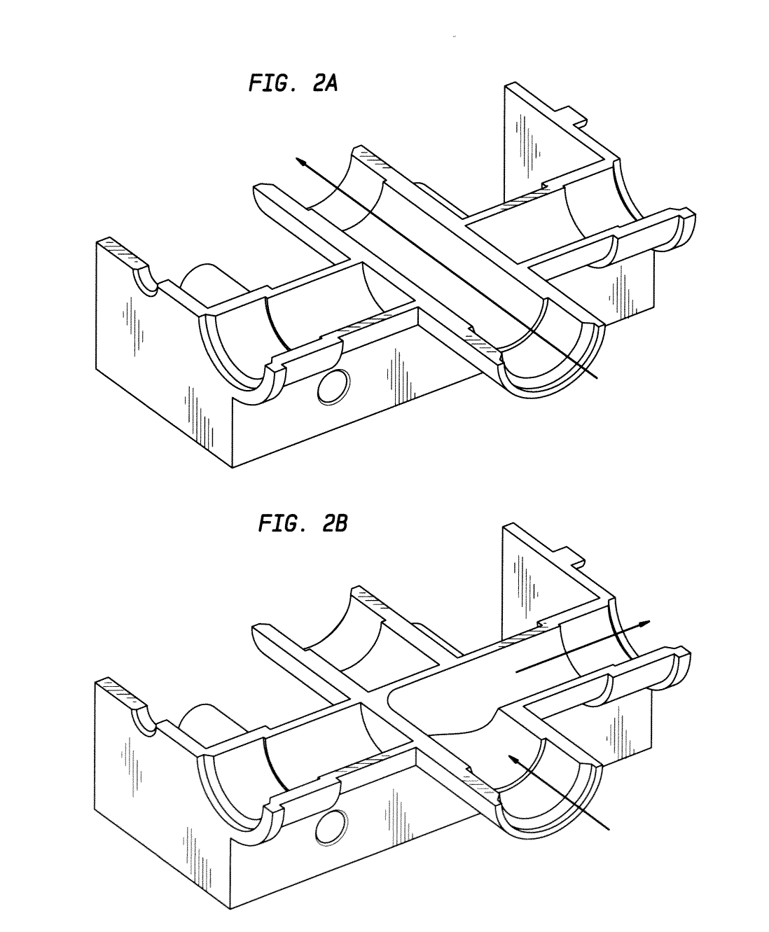

FIG. 1a through 1c show an example of a manifold block with two internal flow passages: one for the high pressure feed stream to the elements and the other for the permeate from the elements. Each flow passage, or flow channel, the nomenclature refer to the same thing, has at least one entry port and one exit port for connections to preceding or following blocks or equipment. The high pressure flow passage directs the flow around a 90° turn, a flow configuration called an “elbow” in piping terms. The elbow is formed by removable inserts placed in the mold before injection. The permeate flow passage is straight through with an entry port for the permeate as shown in 1b.

The manifold block described herein has several purposes. It may act as a structural member to the system. For this purpose it has a building block configuration, as shown in FIGS. 1 and 4. The actual strength and load-bearing properties of the block will depend on architectural details, such as block dimensions, wall thickness and type of material used to manufacture the block. The preferred block design is approximately a solid rectangle. However, other shapes may be considered for certain applications. For example, a generally cylindrical element, or a element with a modified hexagonal cross-section may have benefits in some designs. In addition, reinforcing structures or design elements may be added. These could include, but are not limited to, pillars from bottom to top of a block, gussets and/or trusses, and beams. The block may be fabricated with through-going passages to conduct electrical or pneumatic lines, or conduits in order to keep such lines covered and protected.

Another purpose of the manifold blocks is to provide interconnectors for modules and pumps and passageways for liquid transport. A basic, non-limiting design for flow channels or passageways and associated inlets and outlets is shown in FIGS. 1-5 and 8 wherein a high pressure flow and a permeate flow are illustrated.

The modular blocks may be fabricated from different materials and by different techniques. Metallic manifolds, for example, may be fabricated by molten metal molding and final machining or by machining solid metal. In most water treatment applications, however, non-metallic materials are preferred for reasons of cost and corrosion resistance. Injection molding of a thermoplastic material is a preferred method, and potential materials include plastics such as polyphenylene oxide, polyamide, polysulfone and polyethersulfone. Fillers such as mineral fillers, glass or carbon fibers may be added to increase mechanical strength. Mineral fillers may be those commonly used to reinforce thermoplastic polymers, such as carbonates, silicates, silicas, and barium or titanium dioxide.

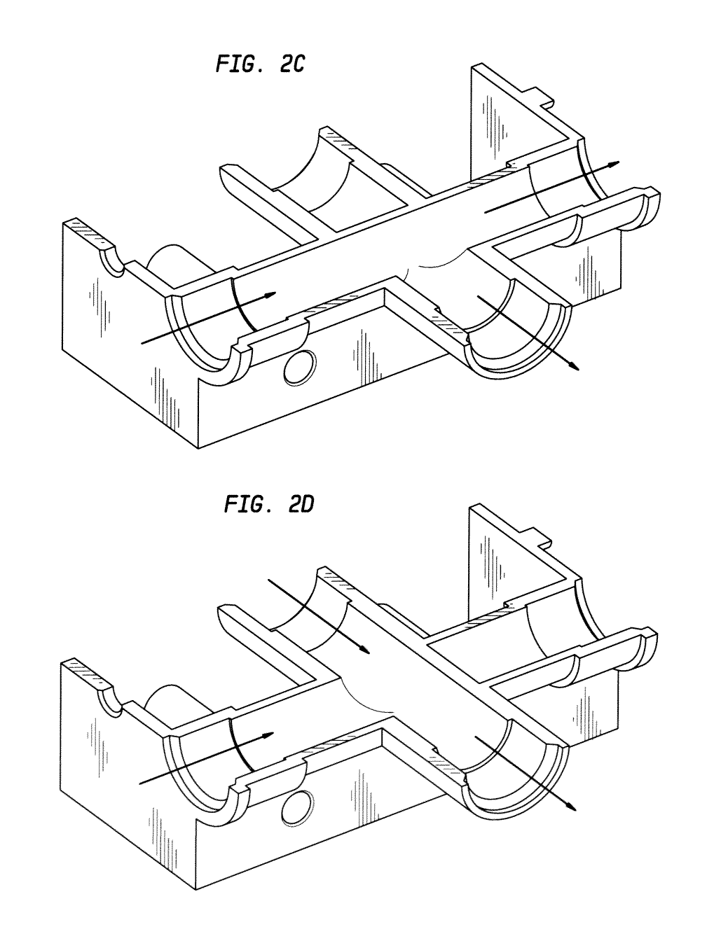

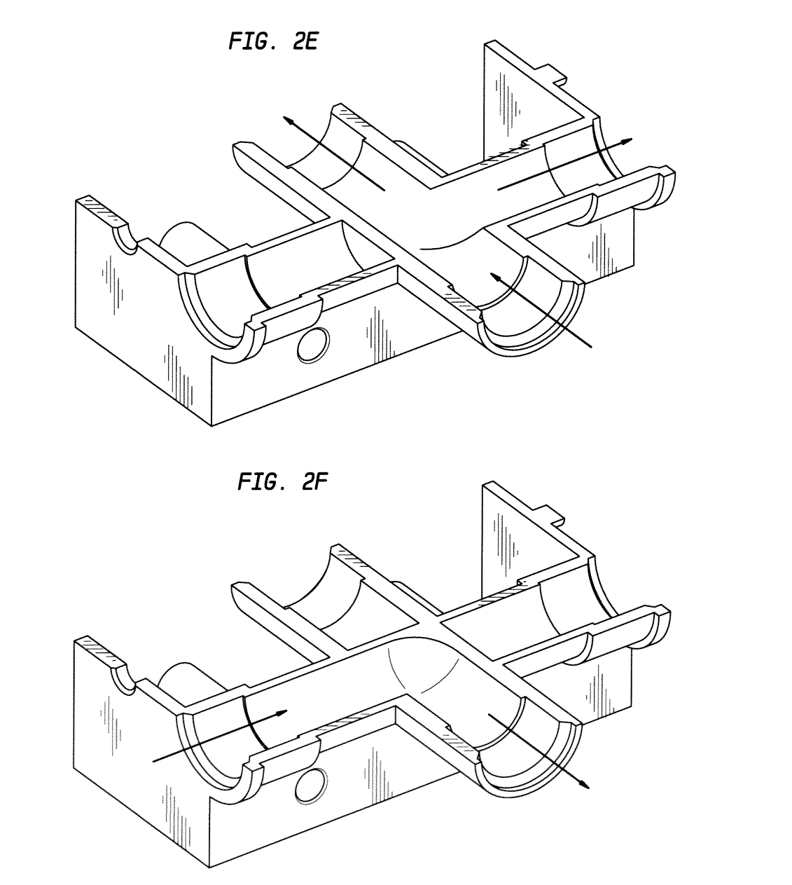

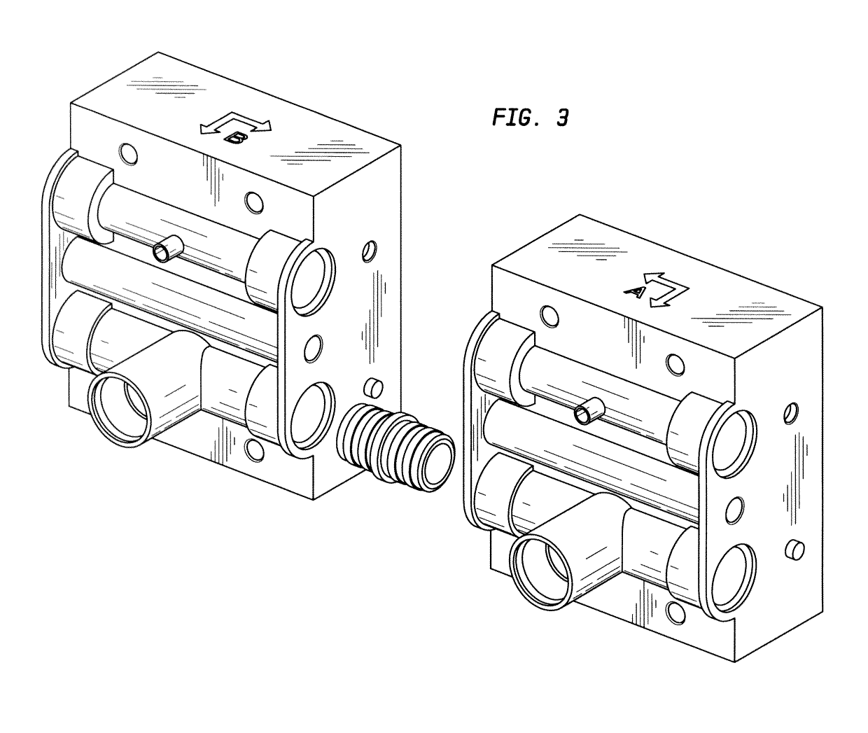

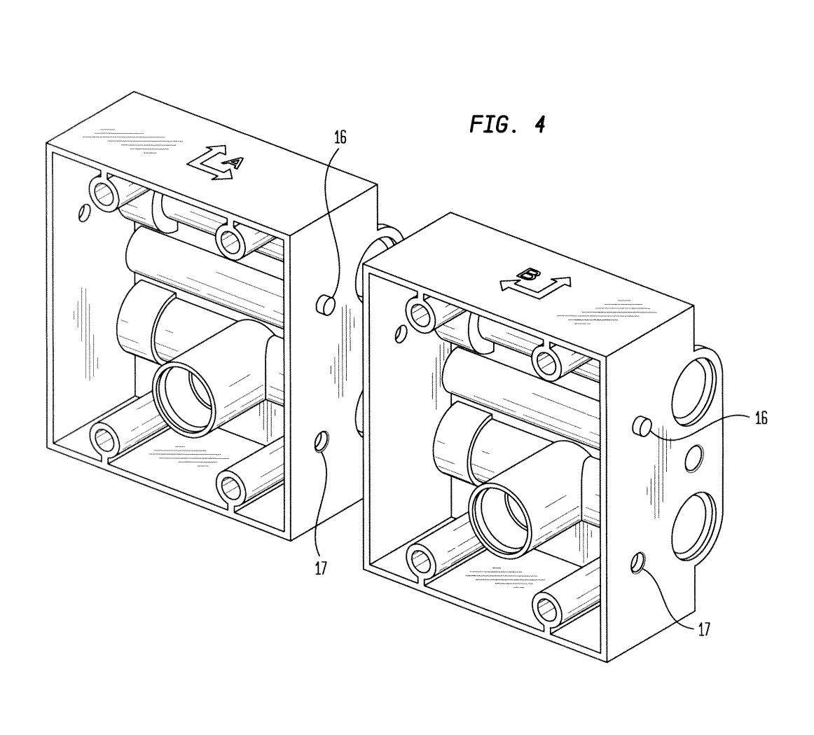

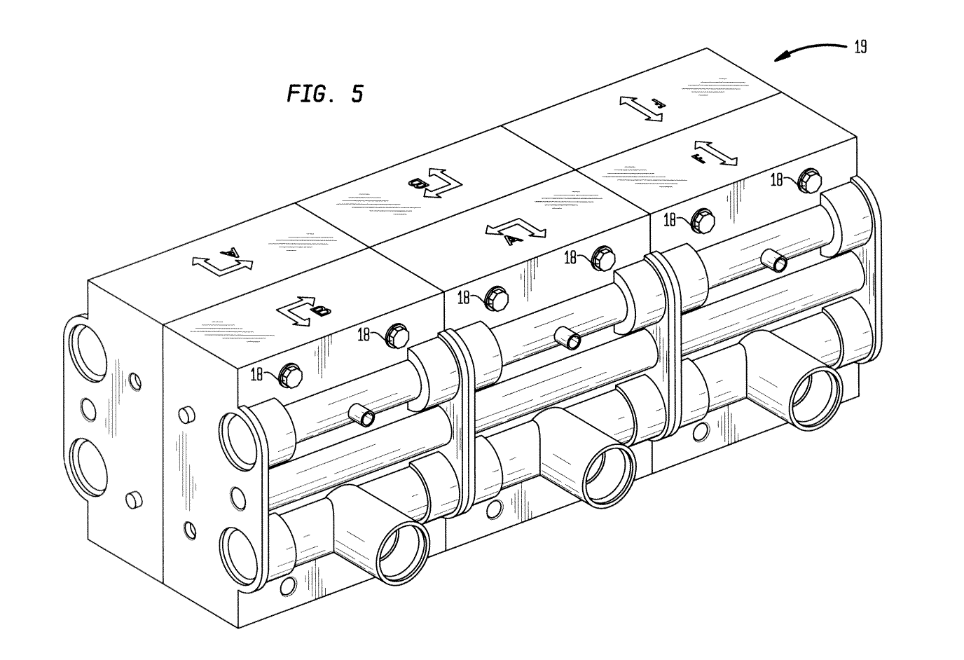

Other versions of manifold blocks may be molded by changing the inserts in the mold. FIG. 2 shows examples with different configurations for the high pressure passages: “forward tee”, “right elbow”, “left elbow”, “right tee”, “left tee”, etc. All of the versions have the same external appearance and substantially the same mechanical strength. They may be fluidly connected, as one example, by molded interconnecting pipe sections (“interconnects”) with O-ring seals, as shown in FIG. 3. Interconnection refers to joining a port of a block with a port of another block or a housing, for example. Examples are the outlet port of a block interconnected (e.g., joined by a interconnecting pipe segment as illustrated in FIG. 3) with the inlet port of an adjacent block.

Other interconnecting methods are possible. The interconnecting pipe section may be in the form of a Tee having a side section to connect to the module. This would simplify molding because the flow passage would be straight through in many cases. In some cases, the interconnects may be a three piece clamp design, as a sanitary clamp fitting or similar. These clamp fittings system have two grooved ferrules each attached to a connector, which would be inserted into a block, a gasket fitted between the ferrules and a clamp to compress the gasket and hold the ferrules together for a leak-proof connection.

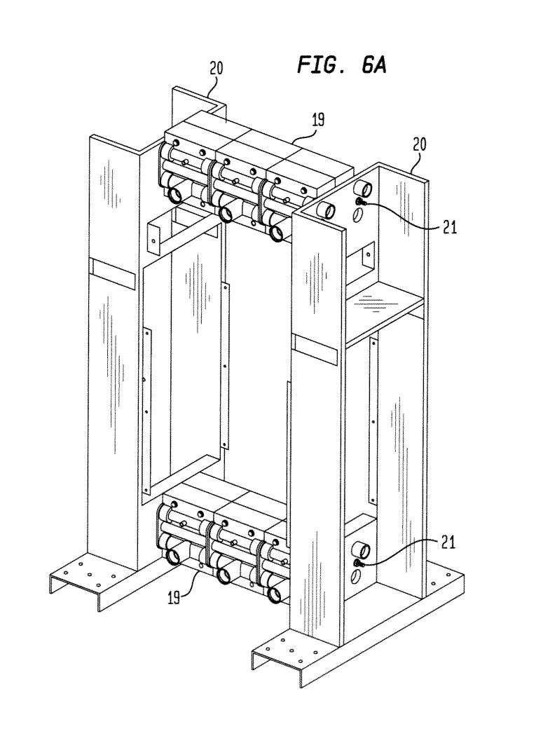

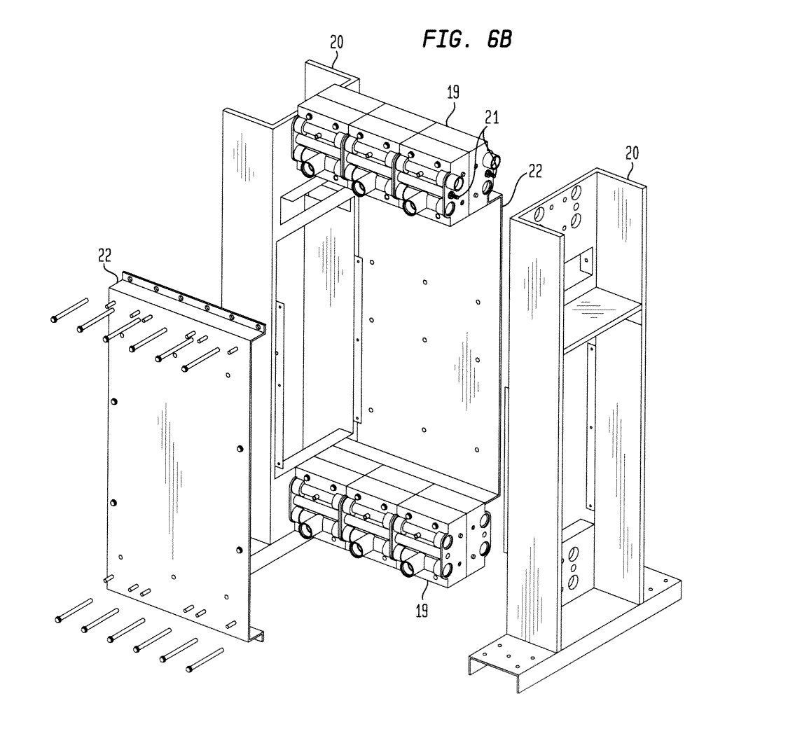

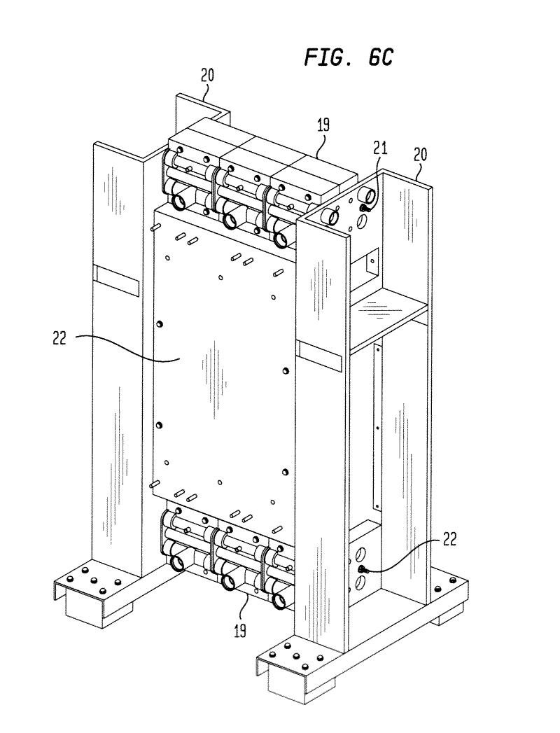

Alternatively, the inlets and outlets of the manifold block may have a circular groove for an O-ring or other gasket type. In this design, a gasket or O-ring would be placed in the mating grooves and the blocks tightened together and securely held in a manner similar, for example, to the threaded rods and nuts as shown in FIG. 6a.

The blocks may be molded into the desired configuration directly using different molds for each form. For ease of use, each configuration could be color coded by incorporating a dye in the injection plastic or otherwise marking the blocks.

The blocks may be molded separately from the flow passages and combined into make the specific manifold needed during system fabrication. For instance, molded flow passages would be designed to be attached or inserted into premolded mating assemblies in the block, and if required, fixed by screw or bolt hardware, or fused by thermal or solvent methods.

The blocks may be molded with a general flow passage such as a Tee and then un-needed passages plugged during system fabrication. The plug could be permanently installed, as by thermal or solvent welding, or removable. An example of the latter would have a threaded plug screwed into molded threads in the flow passage.

Modular blocks may be combined in a variety of geometries. As an example, a linear combination of modular blocks can be aligned by interconnects and molded bosses that mate with molded holes, as shown in FIG. 4. FIG. 5 shows two rows of blocks joined back-to-back with threaded bolts and nuts. FIG. 6a shows four rows of blocks positioned between two vertically oriented metallic channels and clamped in place with the use of threaded rods and nuts. In this example the blocks are essential to the mechanical rigidity of the structure. For larger systems, or where more strength is needed, side panels may be attached as shown in FIG. 6b. A complete support structure for the RO system is shown in FIG. 6c.

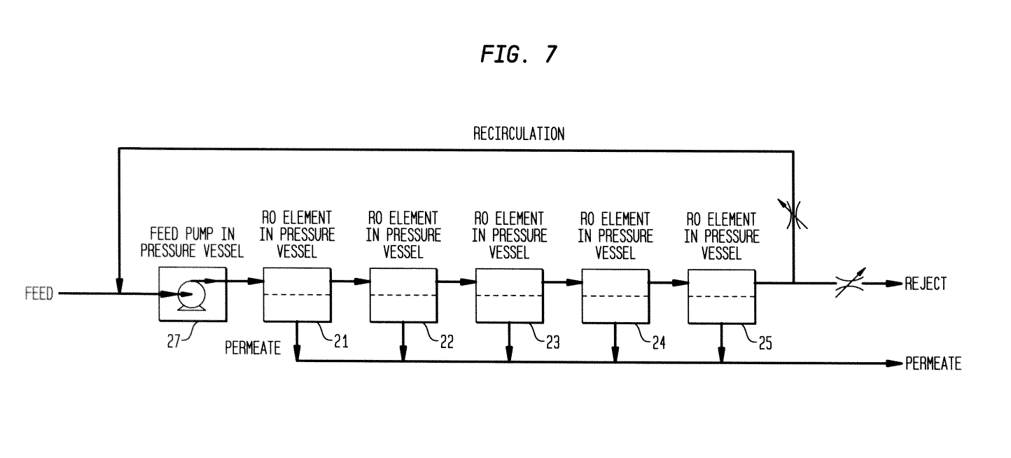

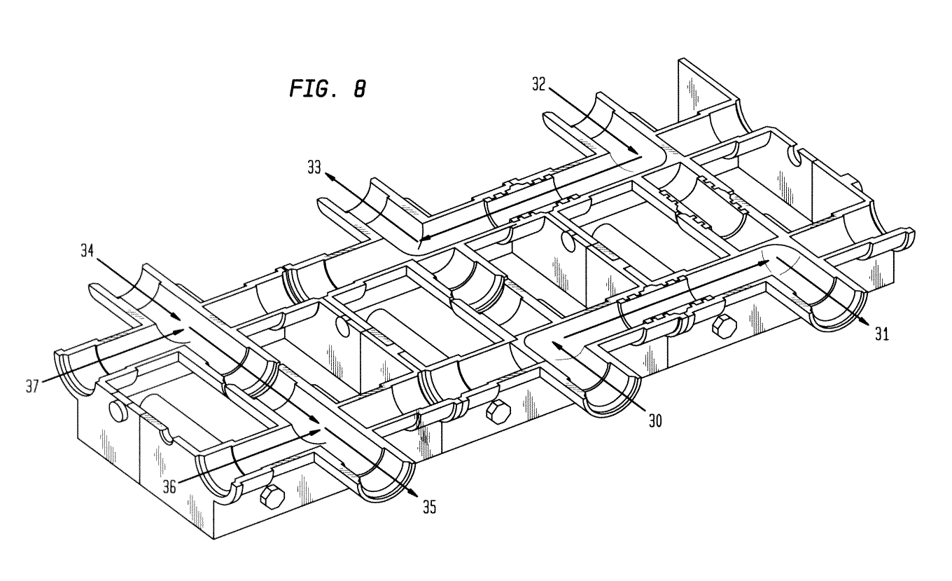

FIG. 7 shows an example of a process schematic for an RO system with six housings. The first housing contains a submerged high pressure pump and the remaining housings contain RO elements arranged in a 1-1-1-1-1 configuration, that is, a series arrangement. FIG. 8 shows the high pressure flow passages in the bottom set of the manifold blocks in the RO system shown in FIGS. 6a through 6c. In this example, a portion of the effluent from the 5^{th}, that is, the last RO housing is recirculated to the suction of the feed pump to increase water recovery. The flow rate recirculated is controlled by an orifice or a flow control valve inserted between two blocks. The remainder of the effluent is depressurized through another flow control orifice or flow control valve and discharged to drain.

Flow also occurs through the upper set of manifold blocks. The upper and lower sets of blocks direct the high pressure flow through the RO housings in accordance with the process schematic shown in FIG. 7. No additional fabricated piping is necessary for a system of this scale.

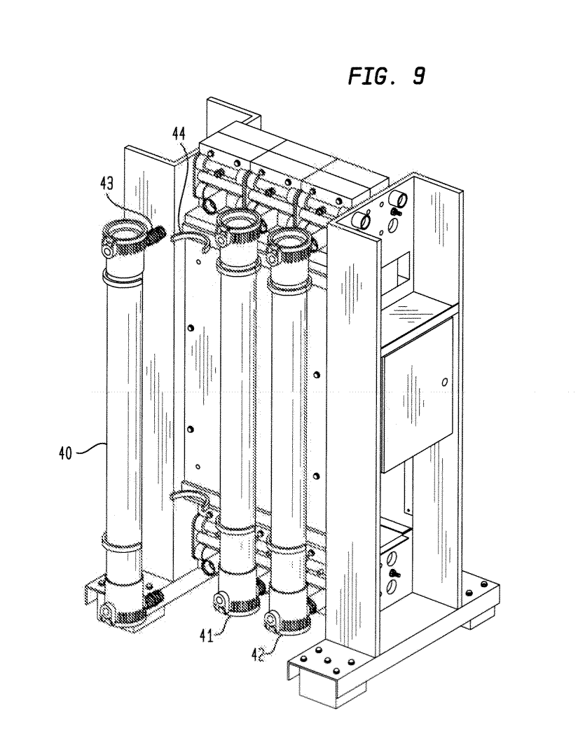

FIG. 9 shows a RO system of the current invention with RO module housings attached. The housings are fluidly connected to the manifold blocks by interconnects and secured to the supporting structure by clamps. The RO elements can be easily removed for off-site cleaning or replacement by releasing the clamps and “unplugging” the housings. In the design shown, a submerged pump is installed in the first housing. These pumps are preferred where low noise and vibration are desired. In addition, the pump can be easily removed for replacement or service by disconnecting the electrical service and removing the module from the manifold blocks by pulling the housing off the interconnectors. In FIG. 3, an interconnector is shown as connecting two blocks. The same interconnector may be used to connect the feed or reject ports of a housing to the perpendicular port of the high pressure channel.

In FIG. 9 there is one RO element per housing. There is no impediment to increasing the number of elements per vessel, as long as there is vertical room to accommodate longer housings.

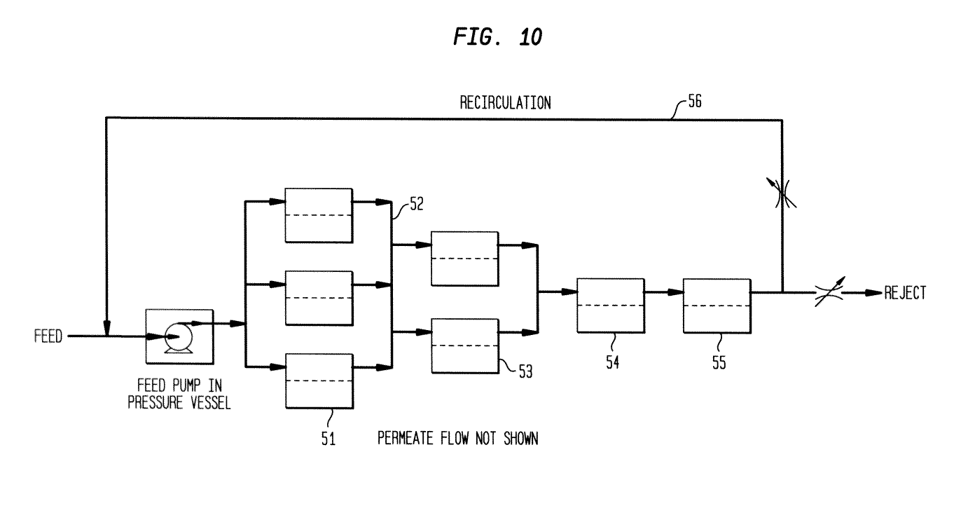

During the design of an RO system the number and arrangement of RO elements are determined to meet specifications on product flow rate, recovery and product quality. FIG. 10 is an example of a process schematic with seven RO elements arranged in a 3-2-1-1 configuration.

Those skilled in the art of water purification by membrane filtration will recognize that nearly all arrangements of RO vessels can be accommodated by proper selection and arrangement of modular blocks with different internal flow passages. While generally described for a small to moderate sized packaged RO system, the attributes of the manifold blocks can be adapted to larger or smaller systems by changes to the size and number of blocks in the system. For large systems with multiple modules per housing, such as 3-5 60 inch long spiral modules per housing, a different configuration is needed. In this case the housings will normally be aligned horizontally and the distance between blocks large, requiring piping between the blocks. Due to the larger flows, larger flow passages and blocks may be required.

The attributes of embodiments described herein have been described for RO systems, but those skilled in the arts of water filtration will easily recognize that the systems built using the blocks may be designed for ultrafiltration membrane and microporous membrane uses, or for adding prefiltration cartridges, whether ultrafiltration, microporous, or non-woven fabric filters to RO systems.

The examples given are meant to be illustrative and are not meant to be limiting. The vertical channels and the side panels in FIG. 6c can be fabricated from glass-reinforced plastic by injection molding, for example. The structural components of the RO system would then primarily be non-metallic and therefore far more corrosion resistant than the typical welded and painted steel frame.

The innovative features of this invention include providing modular blocks with different internal flow passages that can be connected to provide flow manifolds with different flow configurations for RO elements in housings. In addition, the modular blocks of the current invention are molded with identical external dimensions and interlocking features so that they can be mechanically connected and secured to form a substantial portion of the structural support for the RO housings. One of the housings can contain the feed pressurization pump. Further, the current invention provides a structural frame for a RO system consisting of rows of manifold blocks clamped between vertical structural elements at the ends of the rows by threaded rods and side panels attached to the manifold blocks and the vertical structural elements. The vertical structural elements and the side panels can be metallic or non-metallic.

What is claimed is:

1. A high pressure membrane filtration system comprising:
a housing which includes a membrane module, said housing having an inlet port for pressurized feed water, an outlet port for purified water permeate and an outlet port for concentrate water; and
at least two manifold blocks, said blocks having at least a high pressure inlet port fluidly connected by an integral flow channel to an outlet port and at least an inlet port for purified water permeate fluidly connected by an integral flow channel to a permeate outlet port, the high pressure inlet port of one block fluidly connected to a pressurized water source to be purified, and the outlet port of said one block fluidly connected to the inlet port of the housing and
the concentrate outlet port of the housing fluidly connected to the inlet port for pressurized water of another block, whence the pressurized water is conveyed to the concentrate outlet port of the block, and
the permeate outlet port of the housing is fluidly connected to the inlet port of said another block, whence the permeate is conveyed to the outlet permeate port, to provide a purified water product.

2. The system of claim 1 wherein the high pressure membrane filtration system comprises a reverse osmosis membrane filtration system.

3. The system of claim 2 wherein the pressurized water is supplied by a submerged pump contained in a housing fluidly connected to said one block.

4. The system of claim 2 wherein the concentrate outlet is fluidly connected to the pressurized feed to supply a portion of the concentrate flow for recycle.

5. The system of claim 2 wherein the blocks comprise structural members of the system.

6. The system of claim 2 wherein the blocks are injection molded from a thermoplastic polymer.

7. The blocks of claim 6 wherein the thermoplastic polymer is a polysulfone, a polyether sulfone, a polyamide or a polyphenylene oxide.

8. The blocks of claim 6 wherein the polymer is a filled polysulfone, a polyether sulfone, a polyamide or a polyphenylene oxide.

9. The blocks of claim 8 wherein the filled polymers are filled with short glass fibers, carbon fibers, or mineral filler particles.

10. A manifold block capable of increasing the structural rigidity of a reverse osmosis system, said block having at least one integral flow channel, said channel having at least one fluidly interconnectable inlet port and at least one fluidly interconnectable outlet port, said block being a component of a reverse osmosis system having at least two of said blocks, wherein the blocks provide flow channels for the system.

11. The block of claim 10 wherein the blocks are injection molded from a thermoplastic polymer.

12. The blocks of claim 11 wherein the thermoplastic polymer is a polysulfone, a polyether sulfone, a polyamide or a polyphenylene oxide.

13. The blocks of claim 11 wherein the polymer is a filled polysulfone, a polyether sulfone, a polyamide or a polyphenylene oxide.

14. The blocks of claim 13 wherein the filled polymers are filled with short glass fibers, carbon fibers, or mineral filler particles.

15. The blocks of claim 11 wherein the flow channel is selected from the group consisting of a Tee, an elbow, a straight path and combinations thereof.

16. A manifold block capable of increasing the structural rigidity of a reverse osmosis system having at least one integral higher pressure flow channel, said higher pressure channel having at least one fluidly interconnectable inlet port and at least one fluidly interconnectable outlet port, and an integral lower pressure flow channel, said lower pressure channel having at least one fluidly interconnectable inlet port and at least one fluidly interconnectable outlet port, said block being a component of a reverse osmosis system having at least two of said blocks, wherein the blocks provide flow channels for the system.

17. The block of claim 16 wherein the blocks are injection molded from a thermoplastic polymer.

18. The blocks of claim 17 wherein the thermoplastic polymer is a polysulfone, a polyether sulfone, a polyamide or a polyphenylene oxide.

19. The blocks of claim 18 wherein the polymer is a filled polysulfone, a polyether sulfone, a polyamide or a polyphenylene oxide.

20. The blocks of claim 19 wherein the filled polymers are filled with short glass fibers, carbon fibers, or mineral filler particles.

21. The blocks of claim 16 wherein the flow channel is selected from the group consisting of a Tee, an elbow, a straight path and combinations thereof.
